(19) United States
(12) Patent Application Publication
(10) Pub. No.: US 2006/0123003 A1
(43) Pub. Date: Jun. 8, 2006

(54) Method, system and program for enabling non-self actuated database transactions to lock onto a database component

(75) Inventors: Sam Sampson Lightstone, Toronto (CA); Sarah Posner, Toronto (CA); Michael Jeffrey Winer, Markham (CA); Roger Luo Quan Zheng, Richmond Hill (CA)

Correspondence Address: SUGHRUE MION PLLC;USPTO CUSTOMER NO WITH IBM/SVL, 2100 PENNSYLVANIA AVENUE, N.W., WASHINGTON, DC, 20037, US

(73) Assignee: International Business Machines Corporation, Armonk, NY (US)

(21) Appl. No.: 11/008,508

(22) Filed: Dec. 8, 2004

(51) Int. Cl. G06F 17/30

(52) U.S. Cl. 707/8

(57) ABSTRACT

Disclosed are a data processing system implemented method, an article of manufacture and a data processing system for enabling a non-self actuated database transaction to lock onto a database component. The method includes identifying a self actuated transaction currently locking onto the database component, forcing the identified self actuated database transaction to release their lock on the database component if a lock mode between the non-self actuated database transaction and the identified self actuated database transaction is non-compatible, and permitting the non-self actuated database transaction to lock onto the database component if the lock modes between the non-self actuated database transaction and any database transactions currently locking onto the database component are compatible.

### FIELD OF THE INVENTION

The present invention relates to Database Management Systems (DBMSs) in general, and in particular the present invention relates to a data processing implemented method, a data processing system and an article of manufacture for enabling a non-self actuated database transaction to lock onto a database component.

### BACKGROUND

Autonomic computing technology may be used to create self-actuated utilities that may be executed on a data processing system. For example, a self-actuated utility is computer program product that performs maintenance on a database or tuning the performance of a DBMS (Database Management System) without intervention from a user. Since the self-actuated utility is not actuated by the user, the performance of the DBMS may be adjusted automatically. This simplifies DBMS usage enabling users of lower skill level to use the DBMS. Many self-actuated utilities may operate on the DBMS in the background, remaining entirely unknown to the user of the DBMS.

Self-actuated utilities may be called self-actuated transactions (hereinafter called “SAT”) or self actuated database transactions. The SATs may tune performance characteristics of the DBMS for optimum operation in view of existing DBMS conditions. For a SAT to fine tune a database component (i.e., a portion of a database), the SAT may seek a lock on the database component and the DBMS may respond by granting the lock on the database component (if the database component does not already have a lock placed on the component by another process or transaction). Over time, many SATs may hold locks on many database components over an extended period of time, preventing the DBMS from executing user-actuated database transactions on those locked database components and as a result the user-actuated database transaction are forced to wait until those SAT-held locks have been removed. Currently, executed SATs potentially may prevent user-actuated database transactions from being executed by the DBMS.

Accordingly, a solution is desired that addresses, at least in part, these shortcomings.

### SUMMARY

The present invention obviates or mitigates at least some of the above mentioned disadvantages.

In a first aspect of the invention, there is provided a data processing system implemented method of enabling a non-self actuated database transaction to lock onto a database component, the method including identifying a self actuated transaction currently locking onto the database component, forcing the identified self actuated database transaction to release their lock on the database component if a lock mode between the non-self actuated database transaction and the identified self actuated database transaction is non-compatible, and permitting the non-self actuated database transaction to lock onto the database component if the lock modes between the non-self actuated database transaction and any database transactions currently locking onto the database component are compatible.

In a second aspect of the invention, there is provided a a data processing system of enabling a non-self actuated database transaction to lock onto a database component, the data processing system including an identification module for identifying a self actuated transaction currently locking onto the database component, a forcing module for forcing the identified self actuated database transaction to release their lock on the database component if a lock mode between the non-self actuated database transaction and the identified self actuated database transaction is non-compatible, and a permitting module for permitting the non-self actuated database transaction to lock onto the database component if the lock modes between the non-self actuated database transaction and any database transactions currently locking onto the database component are compatible.

In a third aspect of the invention, there is provided an article of manufacture for directing a data processing system to enable a non-self actuated database transaction to lock onto a database component, the article of manufacture including a program usable medium embodying one or more instructions executable by the data processing system, the one or more instructions including instructions for identifying a self actuated transaction currently locking onto the database component, instructions for forcing the identified self actuated database transaction to release their lock on the database component if a lock mode between the non-self actuated database transaction and the identified self actuated database transaction is non-compatible, and instructions for permitting the non-self actuated database transaction to lock onto the database component if the lock modes between the non-self actuated database transaction and any database transactions currently locking onto the database component are compatible.

### BRIEF DESCRIPTION OF THE DRAWINGS

A better understanding of these and other embodiments of the present invention can be obtained with reference to the following drawings and detailed description of the preferred embodiments, in which:

FIG. 1 shows a lock manager installed in a data processing system;

FIG. 2 shows types of database transactions handled by the lock manager of FIG. 1;

FIG. 3 shows a queue managed by the lock manager of FIG. 1;

FIG. 4 shows types of database component status indicators managed by the lock manager of FIG. 1;

FIG. 5 shows a list of database component status indicators assigned to database components by the lock manager of FIG. 1;

FIG. 6 shows a lock mode compatibility look up table used by the lock manager of FIG. 1; and

FIGS. 7A, 7B and 7C show operations of the lock manager of FIG. 1.

Similar references are used in different figures to denote similar components.

### DETAILED DESCRIPTION

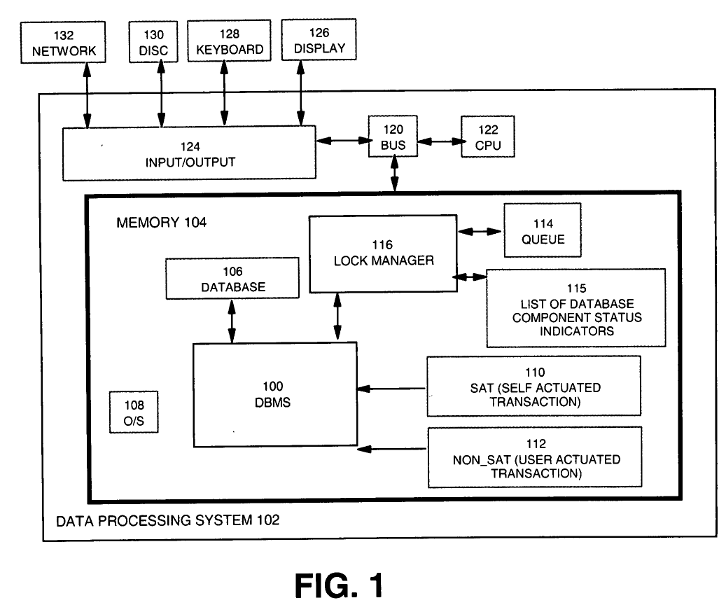

FIG. 1 shows a lock manager (LM) 116 installed a data processing system 102. The purpose of the LM 116 will be described further below. The LM 116 may be used by another data processing system program such as a database management system (DBMS) 100. The LM116 and the DBMS 100 are operatively coupled to a data processing system (DPS) 102. The DPS 102 includes the memory 104 for storing the LM 116, the DBMS 100 and a database 106 having data components. The database 106 may include many types of database components such as data tables, indexes and the like. The memory 104 may include a suitable combination of RAM (Random Access Memory), ROM (Read-only Memory) and the like. The memory 104 also stores an operating system (O/S) 108 which is used to coordinate the operational tasks to be executed by the DPS 102 (such tasks are included in the LM 116 and the DBMS 100). The DPS 102 includes other data processing system components such as a CPU 122 coupled to a BUS 120. The BUS 120 operationally couples the memory 104, the CPU 122 and the INPUT/OUTPUT Interface Unit (I/O I/F) 124. Coupled to the I/O I/F 124 are a network 132, a disc 130, a keyboard/mouse 128 and a monitor/display 126. Also stored in the memory 104 is a queue 114 which is used by the LM 116 (which use is explained further below). In one embodiment, the DBMS 100 may include the LM 116. Yet in another embodiment, the DBMS 100 and the LM 116 may remain as separate entities stored in the memory 104.

The DPS 100 may receive database transactions (hereinafter called “transactions”) from either via the network 132 or via the keyboard 128 or other device suitably coupled to the DPS 100. Once the DPS 100 receives the database transactions, the DPS 100 may store them in the memory 104. The stored database transactions may be executed by the DBMS 100 against the database 106 (typically, the database transactions request data which is stored in the database 106). A Self Actuated Transaction (SAT) 110 includes a SAT identification indicator (not shown in FIG. 1) which identifies the SAT 110 as a SAT-type transaction. A User Actuated Transaction (UAT or non-SAT) 112 does not include a SAT identification indicator. It may be appreciated that in an alternative embodiment, the non-SAT type transactions 112 may include a non-SAT indicator while the SAT type transactions 110 do not include the non-SAT indicator. In another alternative embodiment, both the SAT and the non-SAT indicator may be used. For the purposes of describing an example of the invention, the SAT-type transactions 110 include (or are associated with) a SAT indicator while the non-SAT type transactions 112 will not include (or be associated with) any indicator.

Also stored in the memory 104 is a list of database component status indicators 115 which indicates which database components have had a lock placed on them by either a SAT or non-SAT.

The SAT 110 is a module of executable code that interacts autonomously with the DPS 102 and the DBMS 100 (that is, the SAT 110 is self actuating in that it requests the CPU 122 to execute its own code without any intervention from a user of the DPS 102 or the DBMS 100). The non-SAT 112 is another module of executable code which may be submitted by the user and is not self actuated. The SAT 110 may be treated as a low-priority transaction in comparison to the non-SAT 112; in this case, the LM 116 may operate so as to avoid having the user wait for a longer time for their non-SATs 112 to begin executing while currently-executing SATs 110 hold a lock on a database component thus preventing the non-SAT 112 from accessing the currently-locked up database component.

The LM 116 may either grant or deny locks on the database 106 or database components to SAT-type or non-SAT-type transactions. If the LM 116 may grant a lock on a database component to a new transaction depending on certain conditions; for example, if a locked-on transaction has a lock already granted and if lock modes for the new transaction and the locked on transaction are compatible, the LM 116 may grant another lock to the new transaction. However, if the LM 116 denies a lock to a transaction, the transaction is required to wait to receive the lock; for example, the database component may already be locked by another transaction in which the lock modes for each transaction are not compatible.

The LM 116 may be implemented as an article of manufacture for directing the DPS 100 to grant and deny locks to transactions requesting access to database components. An example of the article of manufacture is disc 130. Also, the article of manufacture may be downloaded to the DPS 100 via the network 132. The article of manufacture may include a data processing system usable medium (such as network modulated signals or a readable disc) which tangibly embodies data processing system executable code. The executable code may be compiled from computer programmed instructions written in a computer programming language. Functions of the executable code for implementing the LM 106 will be discussed further below. It will be understood that the description may describe operations to be performed by the LM 116, but it is understood that the executable code directs the CPU 122 of the DPS 102 to perform the operations.

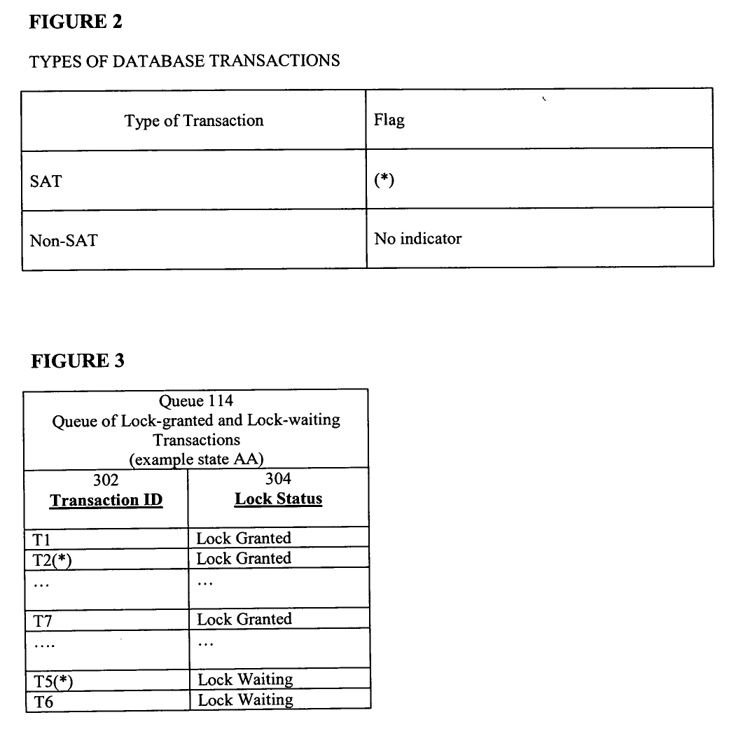

FIG. 2 shows types of database transactions and their associated indicator (that is, transaction type indicator). A transaction type indicator (*) is used to indicate that a transaction is of the SAT type, and that presence of the (*) indicator in the transaction indicates that the transaction is an SAT type transaction. Absence of the (*) indicator indicates the transaction is of the non-SAT type.

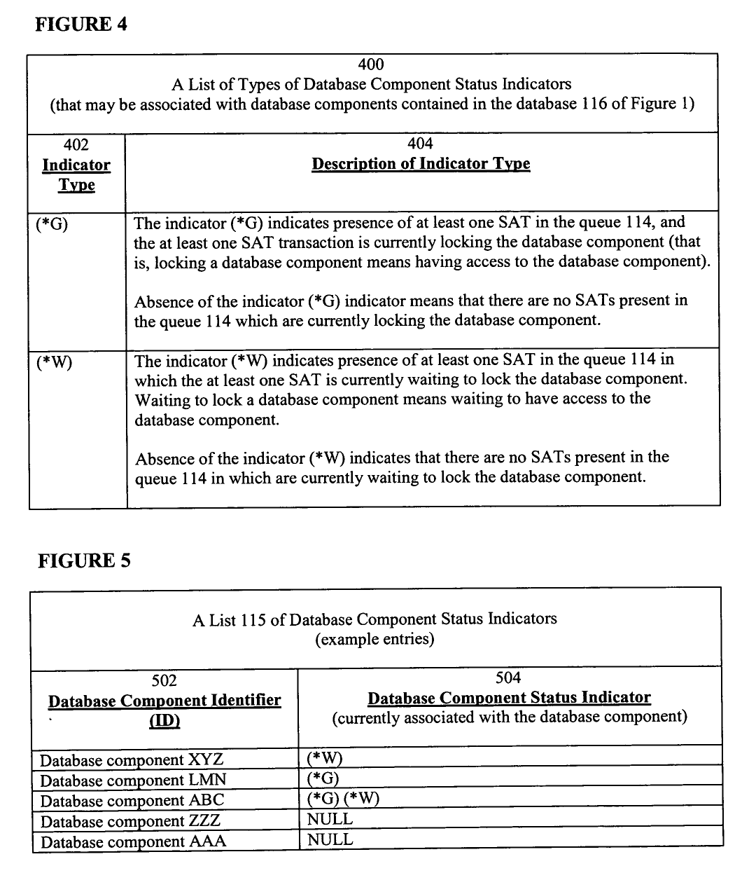

FIG. 3 shows the queue 114 of FIG. 1. The queue 114 represents a queue of lock-granted and lock-waiting transactions. The queue 114 is shown in an exemplary state (AA) in which the queue 114 indicates which transactions currently hold a lock on some database component and which transactions are currently waiting for a lock on some database component. Column 302 shows the transaction identifier (ID) and column 304 shows the lock status of a corresponding transaction ID. A portion of the queue 114 may be used for placing the transactions IDs which have been granted a lock on some database component, and another portion of the queue 114 may be used for placing the transaction IDs which have not yet been granted a lock but are waiting to be granted a lock on some database component. The position of the transaction within the portion of the queue 114 may indicate the duration of time that the transaction may have been placed in the queue 114. For example, transaction T1 may have been placed in the queue 114 after transaction T2(*) has been placed in the queue 114.

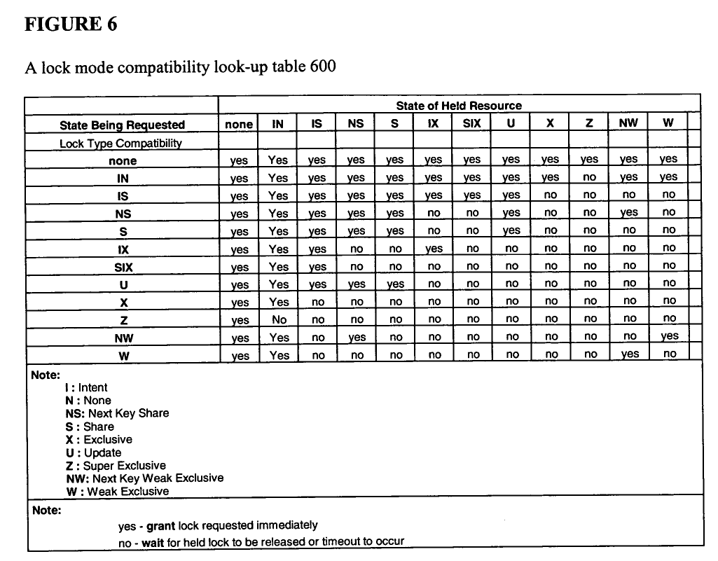

FIG. 4 shows a list 400 of types of database component status indicators that may be associated with database components contained in the database 106 of FIG. 1. Column 402 shows the indicator type and column 404 shows the description of the associated indicator type. An indicator (*G) indicating the presence of at least one SAT is identified in the queue 114. The indicator (*G) also indicates that the at least one SAT is currently locking some database component. Absence of the indicator (*G) means that there are no SATs that are present in the queue 114 which are currently locking the database component.

An indicator (*W) indicates presence of at least one SAT transaction is identified in the queue 114 in which the at least one SAT is currently waiting to lock the database component. Waiting to lock a database component means waiting to have access to the database component. Absence of the indicator (*W) indicates that there are no SAT present in the queue 114 in which are currently waiting to lock the database component.

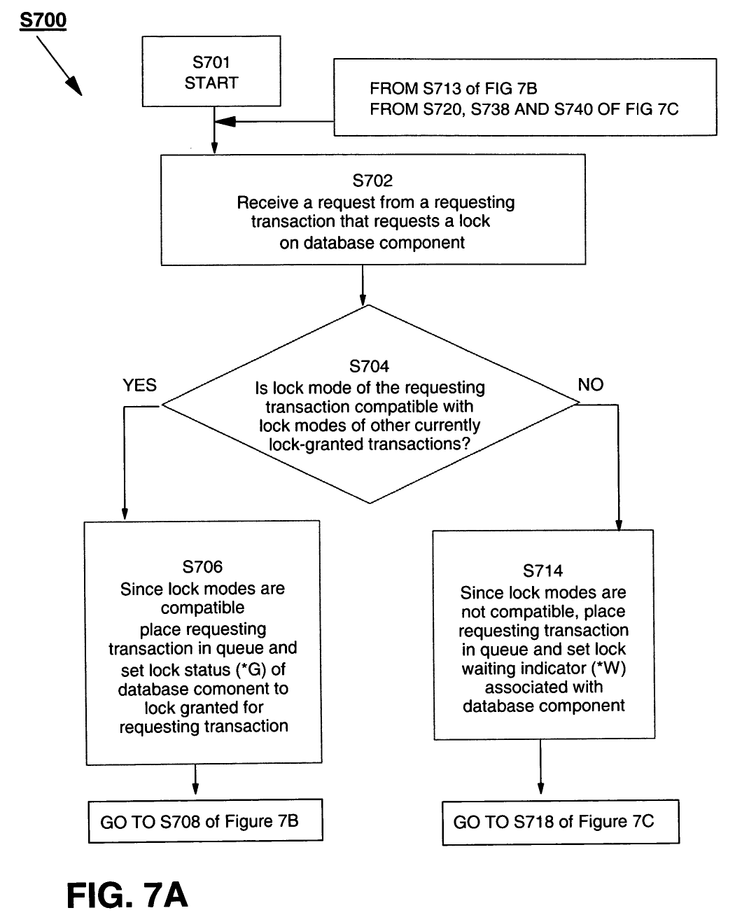

FIG. 5 shows a list 115 of database component status indicators (hereinafter referred to as the look-up table) stored in the memory 104 of the DPS 102 of FIG. 1. There maybe one or more or no database component status indicators associated with the database component identifiers stored in the look-up table. Column 502 shows the database component identifier and column 504 shows the database component status indicators that are currently associated with the database component. List 115 shows that there is a SAT currently waiting to place a lock on a database component XYZ, while there is another SAT which has currently placed a lock on a database component LMN.

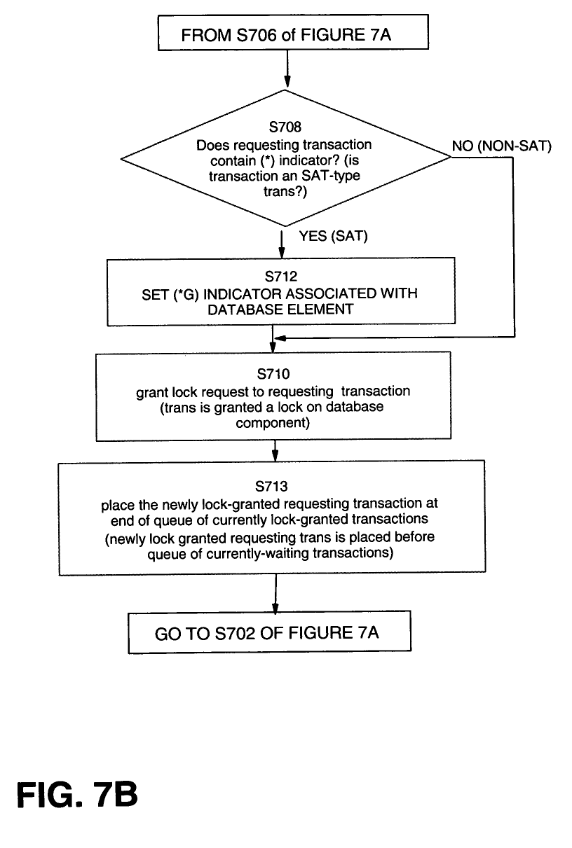

FIG. 6 shows a lock mode compatibility look-up table 600 stored in the memory 104 of the DPS 102 of FIG. 1. The table 600 displays information about conditions in which a request for a lock on a database component may be granted to a database transaction when another database transaction may be currently holding or may be currently requesting a lock on the database component. A lock mode compatibility indicator set to “NO” indicates that a database transaction must wait to lock onto the database component until all incompatible locks are released by other database transactions which are currently locking onto the database component. A timeout may occur when a transaction is waiting for a lock. A lock mode compatibility indicator set to “YES” indicates that a lock may be granted unless an earlier transaction is currently waiting for the database component.

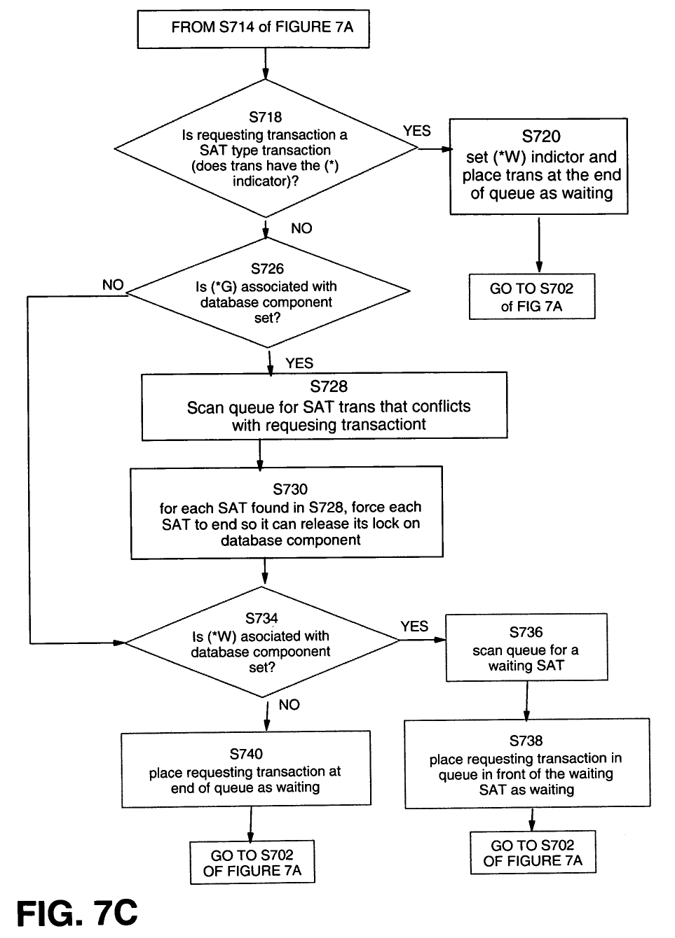

FIGS. 7A, 7B and 7C show operations S700 of the LM 116 of FIG. 1.

Operation S701 begins initialization of the LM 116.

For operation S702, the LM 116 receives a request from a transaction that requests a lock on a database component. For example, the LM receives a request from a transaction T10 (*) which happens to be a SAT-type transaction. Also, the LM 116 may receive another request from a transaction T12 which happens to be a non-SAT-type transaction. For the sake of simplifying the description, both T10 (*) and T12 have a need to access a database component AAA (not shown).

For operation S704, the LM 116 determines whether a lock mode of the received request is compatible (or is not compatible) with lock modes of other currently lock-granted transactions. This may be achieved by referring to the queue 114 and the lock mode compatibility look-up table 600 of FIG. 6.

If the LM 116 determines that the lock mode of the requesting transaction is compatible with the lock modes of currently lock-granted transactions, control may then be transferred over to operation S706. However, if the LM 116 determines that the requesting transaction has a lock mode which is not compatible with the lock modes of other currently lock-granted transactions, control is may then be transferred to operation S714.

For operation S706, since the LM 116 determined that the lock modes were compatible, the LM 116 places the requesting transaction into the queue 114 and sets a lock status (of the requesting transaction) to lock granted.

For operation S708, the LM 116 determines whether the requesting transaction (which was newly inserted in to the queue 114) is either a non-SAT or a SAT. If the LM 116 determines that the requesting transaction is a non-SAT, control is then transferred over to operation S710. If the LM 116 determines that the requesting transaction is a SAT, control is then transferred over to operation S712.

For operation S710, the LM 116 grants (to the requesting transaction) a lock on the database component AAA.

For operation S713, the LM 116 places the newly lock-granted transaction at the end of queue of lock-granted transactions. The newly lock-granted transaction is placed before queue of currently-waiting transactions. Once this task is completed, control may then be transferred back to operation S702 in which case the LM 116 may ready itself for receiving and processing another new request from another requesting transaction.

For operation S712, the LM 116 inserts or sets the (*G) indicator into the list 115 so that, for example, the (G*) indicator is associated with the database component ID for database component AAA.

If the (*G) indicator already exists in the list 115, the LM 116 does not have take any further action to amend the list 115. Once the LM 116 has made sure that the list 115 includes the (*G) indicator, the LM 116 may then check to make sure that the newly inserted SAT type requesting transaction is placed at the end of the portion of the queue 114 for lock-granted transactions. Once the queue 114 has been adjusted, the LM 116 grants a lock on the database component to the requesting transaction. Now control may then be transferred back to operation S702 in which case the LM 116 may ready itself for receiving and processing another new requesting transaction.

If it was determined in operation S704 that the lock mode of the requesting transaction is not compatible with lock modes of other currently lock-granted transactions, control becomes transferred over to operation S714.

For operation S714, the LM 116 places the requesting transaction in the queue 114 and then sets a lock-waiting indicator for the requesting transaction. For example, supposing that the transaction T10 (*) and the transaction T12 each have lock modes which are not compatible with any lock mode associated with a currently lock-granted transactions, the LM 116 inserts the transactions T10 (*) and T12 into the queue 114 and associates a lock-waiting status indicator with T10(*) and T12.

For operation S718, the LM 116 determines whether the requesting transaction is a SAT-type transaction (that is, does transaction have the (*) indicator). If the LM 116 determines that the requesting transaction is a SAT, control is transferred to operation S720. If the LM 116 determines that the requesting transaction is non-SAT, control is then transferred over to operation S726.

For operation S720, the LM 116 sets the (*W) indicator next to the identified database component located in the list 115, and places the requesting transaction at the end of the queue 114 (that is, places the requesting transaction in the waiting portion of the queue 114). Once operation S720 is executed, control is transferred back to operation S702.

For operation S726, the LM 116 determines whether the (*G) indicator is set (or had been set). If the LM 116 determines that the (*G) indicator for the database component AAA has been set, control is transferred to operation S728. If the LM 116 determines that the (*G) indicator for the database component AAA has not been set, control is then transferred over to operation S734.

For operation S728, the LM 116 scans the queue 114 for any potential SAT-type transactions that may conflict with the requesting transaction. This operation may be implemented as a do loop and iteratively performed.

For operation S730, the LM 116 (for each SAT-type transaction found in operation S728) force the SAT to end so that the SAT may release its lock on the database component AAA.

For operation S734, the LM 116 determines whether the (*W) indicator was set for the database component AAA. If the LM 116 determines that the (*W) indicator was set, control may be transferred to operation S736. If the LM 116 determines that the (*W) indicator was not set, control may then be transferred over to operation S740.

For operation S736, the LM 116 scans the queue 114 for a waiting SAT-type transaction.

For operation S738, the LM 116 places the requesting transaction in the queue 114 in front of the waiting SAT (that was found in operation S736). The requesting transaction in placed in the waiting portion of the queue 116. It will be appreciated that operations S736 and S738 may be performed iteratively in a programmed do loop. Once the queue 114 has been completely scanned, operation may be transferred back to operation S702.

For operation S740, the LM 116 places the requesting transaction at end of the queue 114 (that is, in the waiting portion of the queue 114).

The detailed description of the embodiments of the present invention does not limit the implementation of the embodiments to any particular computer programming language. The computer program product may be implemented in any computer programming language provided that the OS (Operating System) provides the facilities that may support the requirements of the computer program product. A preferred embodiment is implemented in the C or C++ computer programming language (or may be implemented in other computer programming languages in conjunction with C/C++). Any limitations presented would be a result of a particular type of operating system, computer programming language, or data processing system and would not be a limitation of the embodiments described herein.

It will be appreciated that the elements described above may be adapted for specific conditions or functions. The concepts of the present invention can be further extended to a variety of other applications that are clearly within the scope of this invention. Having thus described the present invention with respect to preferred embodiments as implemented, it will be apparent to those skilled in the art that many modifications and enhancements are possible to the present invention without departing from the basic concepts as described in the preferred embodiment of the present invention. Therefore, what is intended to be protected by way of letters patent should be limited only by the scope of the following claims.

1. A data processing system implemented method of enabling a non-self actuated database transaction to lock onto a database component, the method comprising:
identifying a self actuated transaction currently locking onto the database component;
forcing the identified self actuated database transaction to release its lock on the database component if a lock mode between the non-self actuated database transaction and the identified self actuated database transaction is non-compatible; and
permitting the non-self actuated database transaction to lock onto the database component if the lock modes between the non-self actuated database transaction and any database transactions currently locking onto the database component are compatible.

2. The data processing system implemented method of claim 1 further comprising:
associating a transaction type identifier identifying whether at least one of the self actuated transaction is a self actuated transaction type and the non-self actuated transaction is a non-self actuated transaction type.

3. The data processing system implemented method of claim 1 further comprising:
permitting the non-self actuated database transaction to lock onto the database component before other currently lock-waiting self actuated database transactions are permitted to lock onto the database component.

4. The data processing system implemented method of claim 1 further comprising:
associating a lock-granted indicator with the database transaction component if a non-self actuated database transaction has been allowed to lock onto the database component, the lock-granted indicator indicating that the database component is currently being locked onto by the self-actuated database transaction;
wherein the identifying the self actuated transaction currently locking onto the database component is based on a status of the lock granted indicator.

5. The data processing system implemented method of claim 1 further comprising:
associating a lock-waiting indicator with the database component if a non-self actuated database transaction has been denied locking onto the database component, the lock-waiting indicator indicating that the database component is waiting to be locked on by the self-actuated transaction; and
determining if the self actuated database transaction is currently waiting to lock onto the database component based on the lock-waiting indicator.

6. The data processing system implemented method of claim 1 further comprising:
associating a database transaction type indicator with a database transaction, the database transaction indicator indicating whether the database transaction is one of a self actuated transaction type and a non-self actuated transaction type; and
determining the transaction type of a given transaction based on the database transaction type indicator.

7. A data processing system of enabling a non-self actuated database transaction to lock onto a database component, the data processing system comprising:
an identification module for identifying a self actuated transaction currently locking onto the database component;
a forcing module for forcing the identified self actuated database transaction to release its lock on the database component if a lock mode between the non-self actuated database transaction and the identified self actuated database transaction is non-compatible; and
a permitting module for permitting the non-self actuated database transaction to lock onto the database component if the lock modes between the non-self actuated database transaction and any database transactions currently locking onto the database component are compatible.

8. The data processing system of claim 7 further comprising:
an associating module for associating a transaction type identifier identifying whether at least one of the self actuated transaction is a self actuated transaction type and the non-self actuated transaction is a non-self actuated transaction type.

9. The data processing system of claim 7 further comprising:
a permission module for permitting the non-self actuated database transaction to lock onto the database component before other currently lock-waiting self actuated database transactions are permitted to lock onto the database component.

10. The data processing system of claim 7 further comprising:
an association module for associating a lock-granted indicator with the database transaction component if a non-self actuated database transaction has been allowed to lock onto the database component, the lock-granted indicator indicating that the database component is currently being locked onto by the self-actuated database transaction;
wherein the identification module for identifying the self actuated transaction currently locking onto the database component is based on a status of the lock granted indicator.

11. The data processing system of claim 7 further comprising:
an associating module for associating a lock-waiting indicator with the database component if a non-self actuated database transaction has been denied locking onto the database component, the lock-waiting indicator indicating that the database component is waiting to be locked on by the self-actuated transaction; and
a determining module for determining if the self actuated database transaction is currently waiting to lock onto the database component based on the lock-waiting indicator.

12. The data processing system of claim 7 further comprising:
an association module for associating a database transaction type indicator with a database transaction, the database transaction indicator indicating whether the database transaction is one of a self actuated transaction type and a non-self actuated transaction type; and
a determination module for determining the transaction type of a given transaction based on the database transaction type indicator.

13. An article of manufacture for directing a data processing system to enable a non-self actuated database transaction to lock onto a database component, the article of manufacture comprising:
a program usable medium embodying one or more instructions executable by the data processing system, the one or more instructions comprising:
instructions for identifying a self actuated transaction currently locking onto the database component;
instructions for forcing the identified self actuated database transaction to release their lock on the database component if a lock mode between the non-self actuated database transaction and the identified self actuated database transaction is non-compatible; and
instructions for permitting the non-self actuated database transaction to lock onto the database component if the lock modes between the non-self actuated database transaction and any database transactions currently locking onto the database component are compatible.

14. The article of manufacture of claim 13 further comprising:
instructions for associating a transaction type identifier identifying whether at least one of the self actuated transaction is a self actuated transaction type and the non-self actuated transaction is a non-self actuated transaction type.

15. The article of manufacture of claim 13 further comprising:
instructions for permitting the non-self actuated database transaction to lock onto the database component before other currently lock-waiting self actuated database transactions are permitted to lock onto the database component.

16. The article of manufacture of claim 13 further comprising:
instructions for associating a lock-granted indicator with the database transaction component if a non-self actuated database transaction has been allowed to lock onto the database component, the lock-granted indicator indicating that the database component is currently being locked onto by the self-actuated database transaction;
wherein the instructions for identifying the self actuated transaction currently locking onto the database component is based on a status of the lock granted indicator.

17. The article of manufacture of claim 13 further comprising:
instructions for associating a lock-waiting indicator with the database component if a non-self actuated database transaction has been denied locking onto the database component, the lock-waiting indicator indicating that the database component is waiting to be locked on by the self-actuated transaction; and
instructions for determining if the self actuated database transaction is currently waiting to lock onto the database component based on the lock-waiting indicator.

18. The article of manufacture of claim 13 further comprising:
instructions for associating a database transaction type indicator with a database transaction, the database transaction indicator indicating whether the database transaction is one of a self actuated transaction type and a non-self actuated transaction type; and
instructions for determining the transaction type of a given transaction based on the database transaction type indicator.
